(19) United States
(12) Patent Application Publication
(10) Pub. No.: US 2016/0215735 A1
(43) Pub. Date: Jul. 28, 2016

(54) THERMAL SCREEN FOR AN EGR COOLER

(71) Applicant: INTERNATIONAL ENGINE INTELLECTUAL PROPERTY COMPANY, LLC., Lisle, IL (US)

(72) Inventor: Andrew K. Stobnicki, Deerfield, IL (US)

(73) Assignee: International Engine Intellectual Property Company, LLC, Lisle, IL (US)

(21) Appl. No.: 14/917,496

(22) PCT Filed: Sep. 11, 2013
(86) PCT No.: PCT/US13/59177

§ 371 Date: Mar. 8, 2016

(51) Int. Cl. F02M 26/29

(52) U.S. Cl. CPC F02M 26/29

(57) ABSTRACT

A thermal screen for use with an exhaust gas recirculation system. The thermal screen is configured to direct the flow of exhaust gases that pass through an exhaust gas recirculation valve toward the tubes of an exhaust gas recirculation cooler. Moreover, the thermal screen is configured to direct the flow of exhaust gases through openings in a header of the exhaust gas recirculation cooler so as to reduce and/or prevent a front surface of the header from being directly exposed to the passing exhaust gases and the heat entrained in those gases. By minimizing and/or preventing the front surface from direct exposure to the exhaust gases, the thermal screen may reduce the thermal strain on the header that is typically associated with differences in temperatures between the front and back surfaces of the header.

### BACKGROUND

Exhaust gas recirculation (EGR) is a technique that is commonly used to reduce nitrogen oxide (NOₓ) emissions in gasoline and diesel internal combustion engines. EGR works by recirculating a portion of an engine's exhaust gas back to the engine's cylinders. For example, EGR may divert exhaust gas to a location upstream of the cylinders, such as, for example, to an intake manifold of the engine. In a gasoline engine, this re-circulated inert exhaust gas displaces an amount of combustible matter in the cylinder. In a diesel engine, the exhaust gas replaces some of the excess oxygen in the pre-combustion mixture. Because NOₓ forms primarily when a mixture of nitrogen and oxygen is subjected to high temperature, the lower combustion chamber temperatures caused by EGR may reduce the amount of NOₓ the combustion event generates. As a result, modern engines commonly use EGR to meet emission standards.

Modern engine systems typically include an electronic engine control unit (ECU) that controls operation of the engine based on measurements provided by a plurality of sensors. Based on at least some measurements provided by sensors, and/or through the ability of the ECU to predict engine operating conditions, the ECU may be able to predict the quantity of exhaust gas that should be diverted by an EGR system back to the engine's cylinders. The ECU may control the quantity of exhaust gas that is to be re-circulated back to the intake manifold of the engine through the operation of a controllable EGR valve.

Exhaust gas that is to be diverted into the EGR system typically encounters an EGR cooler that is configured to reduce the temperature of the exhaust gas. According to certain applications, one or more EGR coolers may be employed to reduce the temperature of the exhaust gas before the exhaust gas is delivered to an intake manifold of the engine. Such reduction in exhaust gas temperatures may be employed to attempt to prevent or minimize the formation of NOₓ during the combustion process in the engine, as well as increase the density of the exhaust gas. According to certain applications, a header of the EGR cooler may be directly coupled to and/or abut an outer surface of an EGR valve housing so that hot exhaust gas that passes through the EGR valve is able to flow out of the EGR valve housing and into the EGR cooler. The exhaust gas flowing through the EGR cooler may then flow through tubes in the EGR cooler and toward another EGR cooler and/or the intake manifold of the engine.

As least a portion of the outer portion of the EGR cooler may be immersed in a coolant, such as a coolant that is utilized by a coolant system for the engine. Accordingly, heat entrained in the exhaust gas that is flowing through tubes of the EGR cooler may pass through the EGR cooler and be absorbed by the cooler coolant flowing outside of the tubes. Such transfer of heat from the exhaust gas to the coolant may reduce the temperature of the exhaust gas in the EGR cooler. However, such reduction in the temperature of exhaust gas that is in the cooler may create a relatively significant temperature gradient across the header of the EGR cooler. For example, a front side of the header that is adjacent to and/or abuts the EGR valve housing may encounter heated exhaust gases that have not yet been cooled in the EGR cooler. Accordingly, through exposure to the uncooled, heated exhaust gases, the front side of the header may attain elevated temperatures, such as, for example, approximately 700° Celsius. However, the backside of the header may encounter coolant and/or cooled exhaust gases, which may result in the backside of the header having a temperature of, for example, approximately 115° Celsius.

Such temperature variances across the front and backsides of the header may result in strains in the header that lead to the formation, and propagation, of cracks in the header. The resulting cracks in the header may provide entry points for coolant to enter into the gas stream, and flow along, one or more tubes of the EGR cooler, and/or may provide entry points for exhaust gas to enter into the coolant system. If coolant were able to enter the tubes of the EGR cooler, the coolant may travel along the tubes and eventually be delivered to the intake manifold of the engine before flowing into an engine cylinder. The presence of such coolant in the cylinder, such as during an intended combustion event, may hinder the performance of the engine and/or result in engine failure. Further, if cracks in the header allow exhaust gas to enter into the coolant system, such entry and resulting presence of exhaust gas may reduce the effectiveness of the coolant system.

### BRIEF SUMMARY

According to certain embodiments, an exhaust gas recirculation system for diverting the flow of an exhaust gas is provided that includes an exhaust gas recirculation housing that is configured to house an exhaust gas recirculation valve. The system further includes a thermal screen that is operably connected to at least a portion of exhaust gas recirculation housing, the thermal screen being positioned downstream of the exhaust gas recirculation valve. The system also includes an exhaust gas recirculation cooler having a header that is positioned downstream of the thermal screen. The thermal screen is configured to direct the flow of exhaust gas through the header so as to minimize direct exposure of a front surface of the header with the exhaust gas.

Additionally, according to certain embodiments, an exhaust gas recirculation system is provided for diverting the flow of an exhaust gas. The exhaust gas recirculation system includes an exhaust gas recirculation housing that is configured to house an exhaust gas recirculation valve. Further, the exhaust gas recirculation housing includes at least one exhaust gas diffuser. The system also includes a thermal screen having a plurality of openings, the thermal screen being operably connected to at least a portion of exhaust gas recirculation housing. The thermal screen is positioned downstream of the at least one exhaust gas diffuser. Additionally, the system includes an exhaust gas recirculation cooler having a header that is positioned downstream of the thermal screen. The openings of the thermal screen are configured to direct the flow of exhaust gas through the header so as to minimize direct exposure of a front surface of the header to the passing exhaust gas.

### BRIEF DESCRIPTION OF SEVERAL VIEWS OF THE DRAWINGS

FIG. 1 illustrates a diesel engine system that includes an EGR valve and header according to an illustrated embodiment.

FIG. 2a illustrates a side perspective view of an EGR valve housing having an EGR valve and a thermal screen according to an illustrated embodiment.

FIG. 2b illustrates a front view of an EGR valve housing having an EGR valve and a thermal screen according to an illustrated embodiment.

FIG. 3 illustrates a cross sectional view of the EGR valve housing taken along line A-A in FIG. 2b.

FIG. 4a illustrates a cross sectional view of the EGR valve housing taken along line B-B in FIG. 2b.

FIG. 4b illustrates a cross sectional view of the EGR valve housing taken along line B-B in FIG. 2b and in which the thermal screen includes one or more extensions.

FIG. 5 illustrates a front view of a thermal screen according to an illustrated embodiment.

FIG. 6 is a side perspective view of the thermal screen shown in FIG. 4.

FIG. 7 is an exploded view of a thermal screen, header, and EGR cooler according to an illustrated embodiment.

FIG. 8 is a side perspective view of a thermal screen having a plurality of extensions according to an illustrated embodiment.

FIG. 9 reflects experimental data that identified hot zones on the header when an EGR system did not include a thermal screen between the exhaust gas diffuser of the EGR valve housing and the header of the EGR cooler.

FIG. 10 is a chart comparing the temperature at the hot zones of FIG. 9 when a thermal screen is, and is not, used to direct the flow of exhaust gases from the exhaust gas diffuser and past the header.

FIG. 11 reflects experimental data that identified hot zones on the header when an EGR system did not include a thermal screen between the exhaust gas diffuser of the EGR valve housing and the header of the EGR cooler.

FIG. 12 is a chart comparing the temperature at the hot zones of FIG. 11 when a thermal screen (with extensions) is, and is not, used to direct the flow of exhaust gases from the exhaust gas diffuser and past the header.

### DETAILED DESCRIPTION

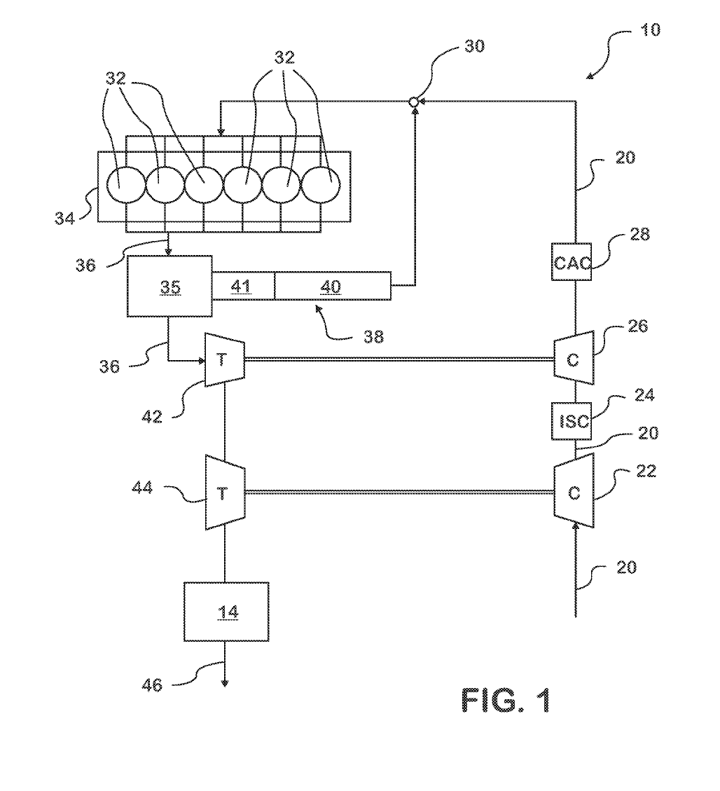

FIG. 1 illustrates a diesel engine system 10 that includes an exhaust gas after-treatment system 14. As shown, air for use in the operation of the engine system 10, such as, for example, for use during an internal combustion process, may flow along an intake line 20 that includes various hoses and/or tubes. For example, air passes along a first portion of the intake line 20 and into a low pressure compressor 22 before flowing along a second portion of the intake line 20 to the interstage cooler 24. The air then flows through a high pressure compressor 26 and high pressure charged air cooler 28 before flowing through another portion of the intake line 20 to an intake manifold 30.

The air may flow through the intake manifold 30 and to cylinders 32 of the engine 34, where the air may be used in a combustion event(s) that is used to displace the pistons of the engine 34, thereby transmitting the force of the combustion event(s) into mechanical power that is used to drive the drivetrain of the associate vehicle. The resulting hot exhaust gas and associated particulate matter, such as soot, produced by or during the combustion event(s) may then flow out of the cylinders 32 and engine 34 through an exhaust port(s) or exhaust manifold and along a exhaust lines 36a, 36b.

According to certain embodiments, at least a portion of the hot exhaust gas from the engine 34 may flow through a first exhaust line 36a and be diverted into the EGR system 38 by an exhaust gas recirculation (EGR) valve that is housed in an EGR valve housing 35. The EGR system 38 may be configured to recirculate the diverted exhaust gas back to the intake manifold 30. However, before the EGR system 38 recirculates the exhaust gas, the exhaust gas is typically cooled by an EGR cooler 40 or heat exchanger. Further, according to certain embodiments, the EGR cooler 40 may include a header 41 that is used in connecting or coupling the EGR cooler 40 to the EGR valve housing 35.

A coolant, such as antifreeze mixtures or non-aqueous solutions, among others, typically circulates through or around the EGR cooler 40. By recirculating cooled exhaust gas back into the intake manifold, the cooled, and possibly higher density, exhaust gas may occupy a portion of the cylinder(s) 32 that may otherwise be occupied by a gas with a relatively high concentration of oxygen, such as fresh air, which may result in a reduction in the temperatures attained in the cylinder 32 during a combustion event. Because NOₓ forms primarily when a mixture of nitrogen and oxygen is subjected to high temperature, lowering the temperature of the combustion event in the cylinder 32 through the use of the cooled exhaust gas re-circulated by the EGR system 38 may reduce the quantity of NOₓ generated as a result of the combustion event.

According to certain embodiments, exhaust gas that is not diverted to the EGR system 38 may flow from an exhaust port(s) or exhaust manifold and through a second exhaust line 36b to a high pressure turbine 42. The exhaust gas, and the heat entrained therein, may then at least assist in driving the high pressure turbine 42. Power generated by the high pressure turbine 42 may at least in part be used to power or drive the high pressure compressor 26. Exhaust gas exiting the high pressure turbine 42 may then flow along the exhaust line 36 to a low pressure turbine 44. The low pressure turbine 44 may also be configured to be driven by the exhaust gas, and the heat entrained therein. Additionally, operation of the low pressure turbine 44 may be used to power or drive the low pressure air compressor 22. According to the embodiment shown in FIG. 1, exhaust gas exiting the low pressure turbine 44 passes through the exhaust line 36 and into the after-treatment system 14 before flowing out a tailpipe 46.

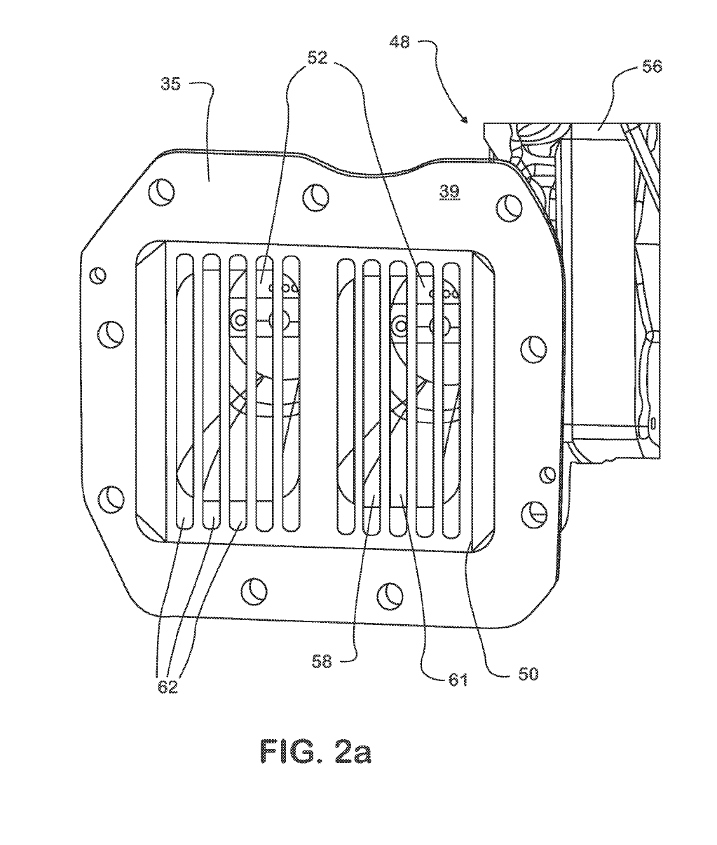

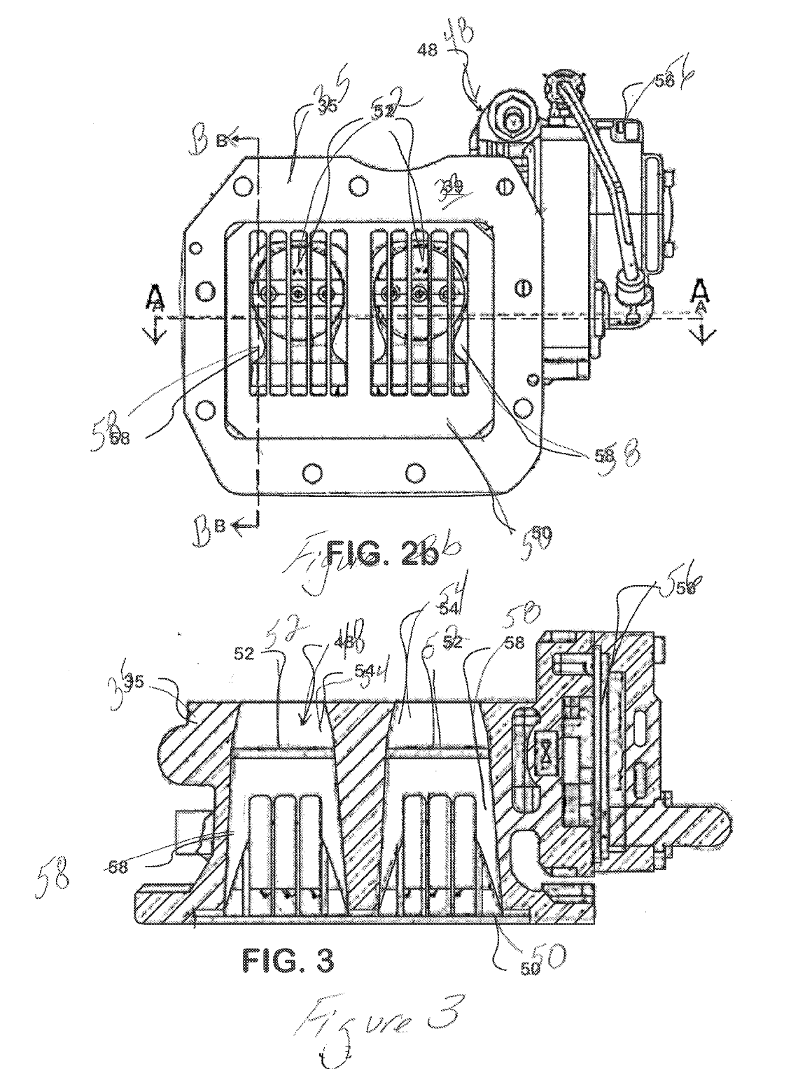

FIGS. 2a, 2b, and 3 illustrate an EGR valve housing 35 having an EGR valve 48 and a thermal screen 50 according to an illustrated embodiment. According to certain embodiments, the EGR valve 48 may include one or more flappers 52 that are positioned in or adjacent to an exhaust gas passageway 54. The flappers 52 may be rotated between open and closed position, such as by the operation of a motor 56. The positioning of the flappers 52 and/or operation of the motor 56 may be controlled by an electronic control unit or module.

As shown at least in FIGS. 2b and 3, when in the closed position, the flapper(s) 52 may provide a barrier that seeks to prevent the flow of exhaust gas past the flapper(s) 52. According to certain embodiments, when the flapper(s) 52 is/are in the closed position, at least a substantial portion of exhaust gas exiting the engine 34 may flow toward the turbines 44, 46 and eventually to the after treatment system 14. However, when at least a portion of the exhaust gas is to be diverted back to the intake manifold 30, the flapper(s) 52 may be at least partially rotated or displaced to allow exhaust gas to flow past the flapper(s) 52 and toward the EGR cooler 40.

After passing a flapper 52, the exhaust gas may proceed into one or more exhaust gas diffusers 58 in the EGR valve housing 35. According to certain embodiments, each flapper 52 may be associated with a dedicated exhaust gas diffuser 58. For example, as shown at least in FIGS. 2b and 3, each flapper 52 is associated with a particular exhaust gas passageway 54 that leads to an exhaust gas diffuser 58 that is associated with that particular exhaust gas passageway 54 and/or flapper 52. The exhaust gas diffuser 58 may terminate at a thermal screen 50 that is operably attached or connected to the EGR valve housing 35. For example, at least a portion of a front surface 51 of the thermal screen 50 may be abut against the EGR valve housing 35. Further, according to certain embodiments, at least a portion of the thermal screen 50 may be positioned within a recess 37 located along a backside surface 39 of the EGR valve housing 35. The recess 37 may be configured to at least allow for a space to be present between the thermal screen 50 and the tubes 66 of the EGR cooler 40. According to certain embodiments, the thermal screen 50 may be secured to the EGR valve housing 35 in a number of different fashions, including, for example, through the use of mechanical fasteners, including pins, screws, and bolts, as well as via one or more welds, among other fasteners.

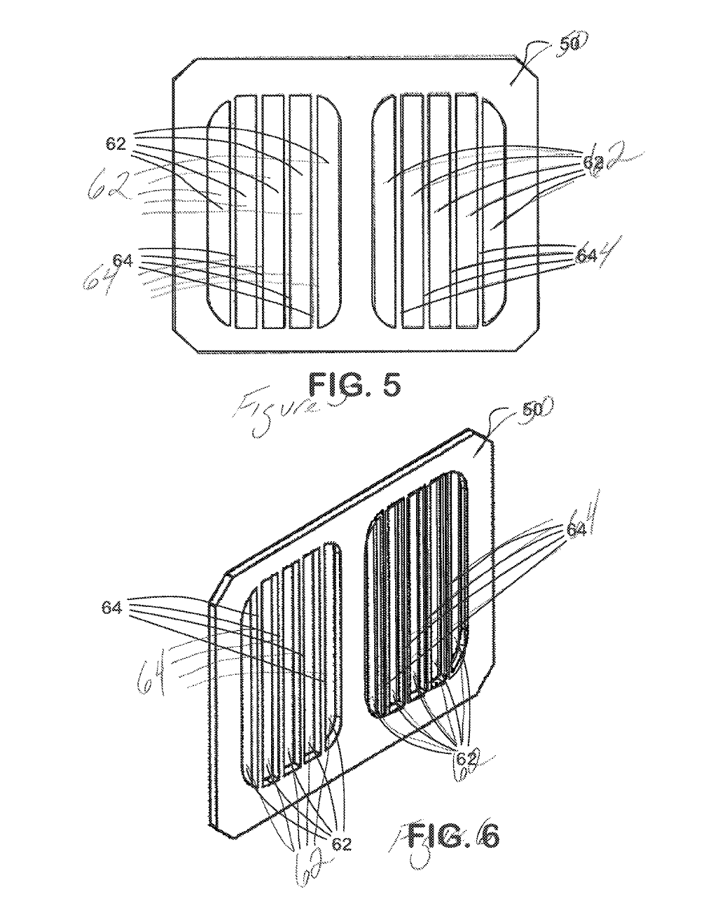

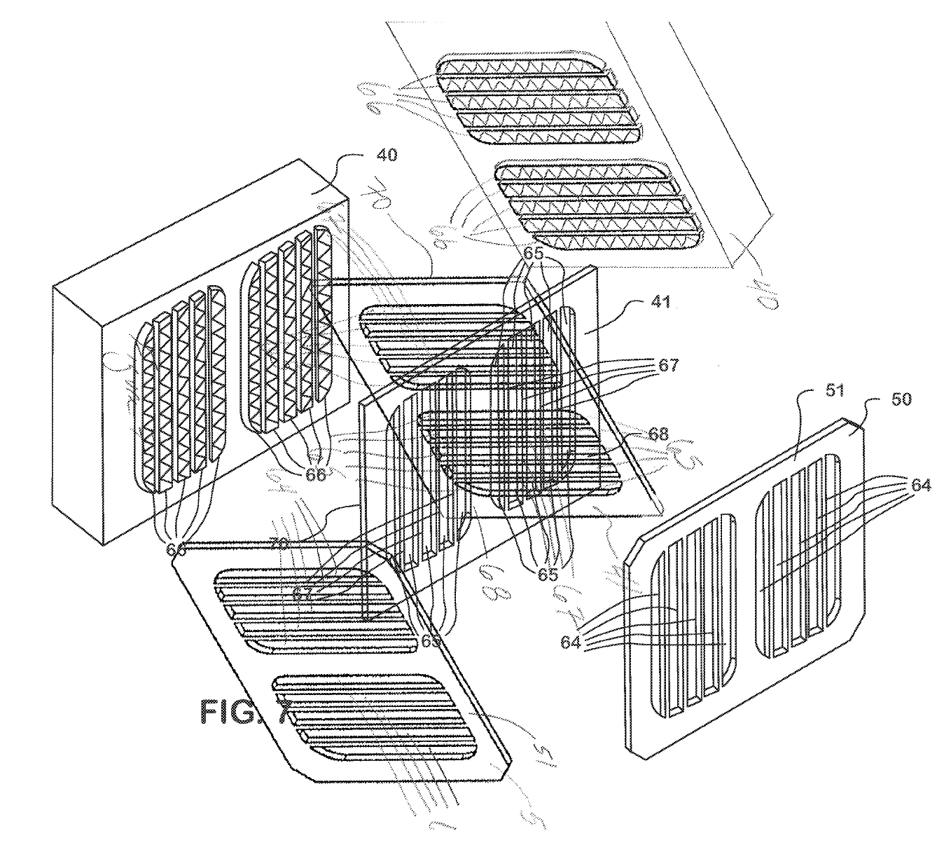

FIGS. 5 and 6 illustrate an embodiment of the thermal screen 50. The thermal screen 50 may be constructed from a variety of different materials, including, for example, metal, such as, for example, 1045 steel and 316 stainless steel, among other materials. Additionally, according to certain embodiments, the thermal plate 50 may be approximately 130 millimeters (mm) long×104 mm wide×3 mm thick.

The thermal screen 50 may include a plurality of openings 62 that direct the flow of exhaust gases into the EGR cooler 40. Moreover, such openings may minimize and/or prevent the header 41 from being directly exposed to hot exhaust gases that are flowing through the header 41. Additionally, the openings 62 may be sized to prevent relatively large debris from entering into the EGR cooler 40. The openings 62 may be separated by one or more dividers 66. The positioning of the openings 62 and dividers 64 may be configured to at least generally match the position and/or configuration of the corresponding openings 65 and dividers 67 in the header 41 and/or tubes 66 of the EGR cooler 40 through which exhaust gas is to flow, as shown for example in FIG. 7. Moreover, the positioning, shape, and/or configuration of the openings 62 of the thermal screen 50 may allow the exhaust gas that is flowing from the exhaust gas diffuser 58 of the EGR valve housing 35 to be directed into the tubes 66 of the EGR cooler 40 with relatively minimal, or reduced, contact of the flowing hot exhaust gas with the front side 68 of the header 41. Such minimal or reduce contact of heated exhaust gas with the front surface 68 of the header 41 may provide a reduced temperature along at least a portion of the front surface 68 of the header 41, and more particularly a reduction in the temperature gradient between the front and backside surfaces 68, 70 of the header 41.

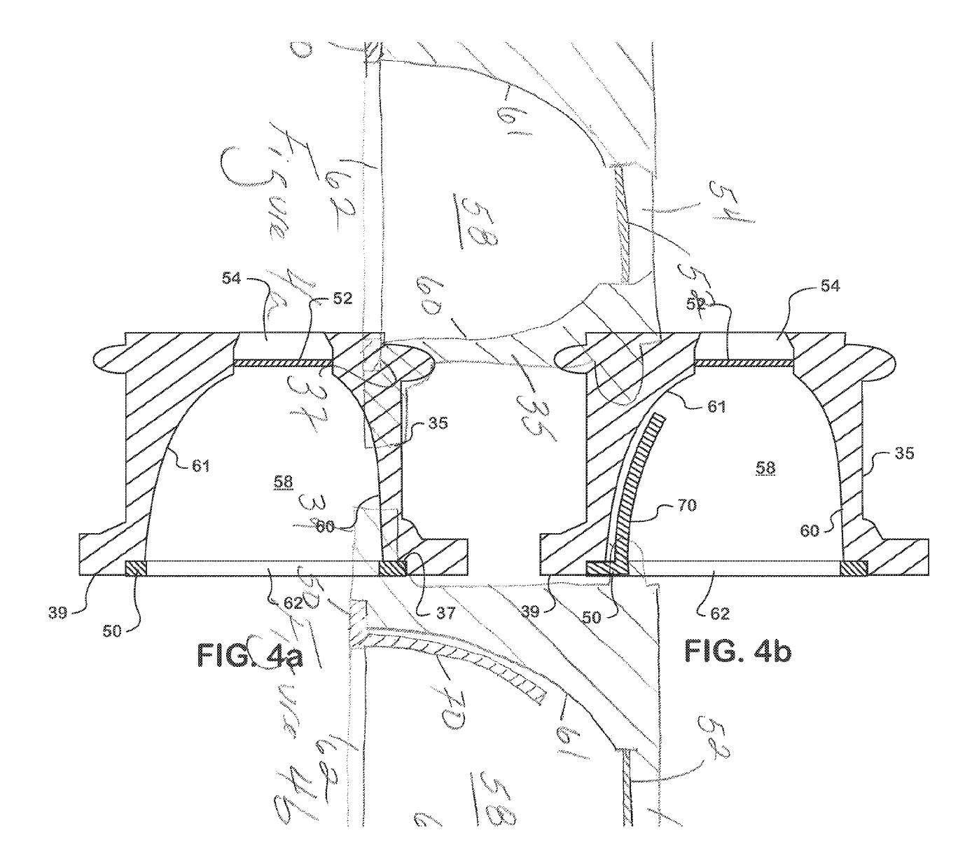

Further, the exhaust gas diffuser 58 may have a variety of different shapes and configurations. For example, according to certain embodiments, the flapper 52 may not be located in a central location relative to the exhaust gas diffuser 58. For example, referencing FIG. 4a, the flapper 52 may be closer to a first sidewall 60 than a second sidewall 61 of the exhaust gas diffuser 58. Further, the sidewalls 60, 61 may have different slopes. As a result, exhaust gas that has entered the exhaust gas diffuser 58 and is traveling along or in proximity to the first sidewall 60 may reach the header sooner than exhaust gas that is traveling along or in proximity to the second sidewall 61. Such differences in travel times for the exhaust gases to reach the header 41 may result in differences in the temperature of the exhaust gas that comes into contact with the adjacent portions of the header 41, which may cause relatively significant temperature differences across a front surface 68 of the header 41.

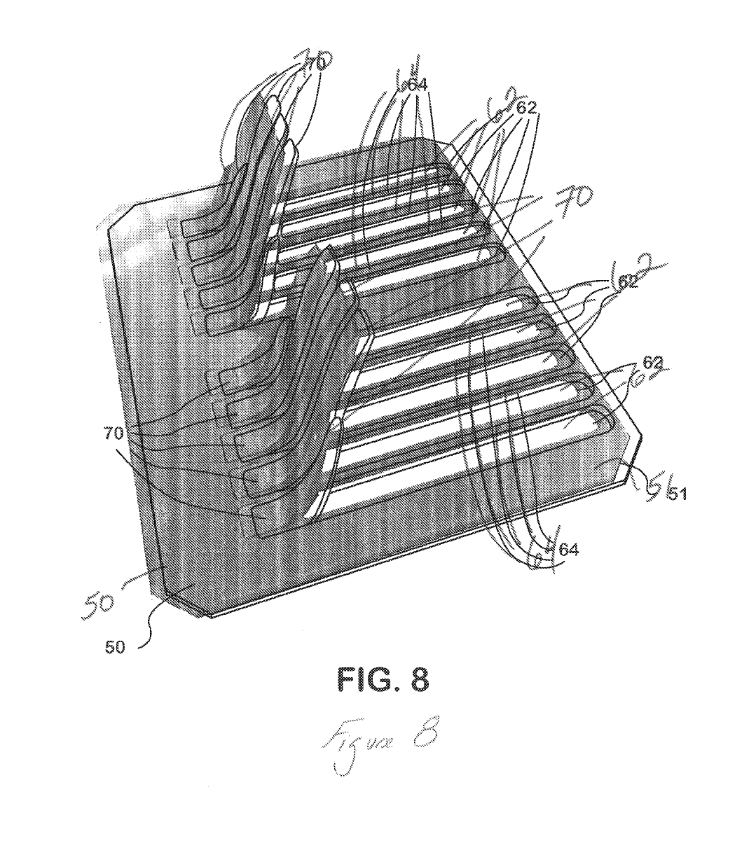

As shown in FIGS. 4b and 8, in at least an effort to address the differences in the configurations and/or locations of the sidewalls 60, 61 in the exhaust gas diffuser 58, according to certain embodiments, the thermal screen 50 may include one or more extensions 70 that are configured to extend into at least a portion of the exhaust gas diffuser 58. Moreover, such extensions 70 may extend from the front surface 51 of the thermal screen 50 and down into the adjacent exhaust gas diffuser 58. According to certain embodiments, the extensions 70 are formed from material removed or displaced from when forming the openings 62 of the thermal screen 50. Further, the extensions 70 may be shaped to generally match, or not match, the slope or shape of the adjacent sidewall 61 of the exhaust gas diffuser 58. Moreover, the extensions 70 may be shaped to facilitate the lifting and travel of exhaust gases toward the openings 62 in the thermal screen 50, such as, for example, to facilitate the inward and upward movement of exhaust gas in the exhaust gas diffuser 58 toward the tubes 66 of the EGR cooler 40.

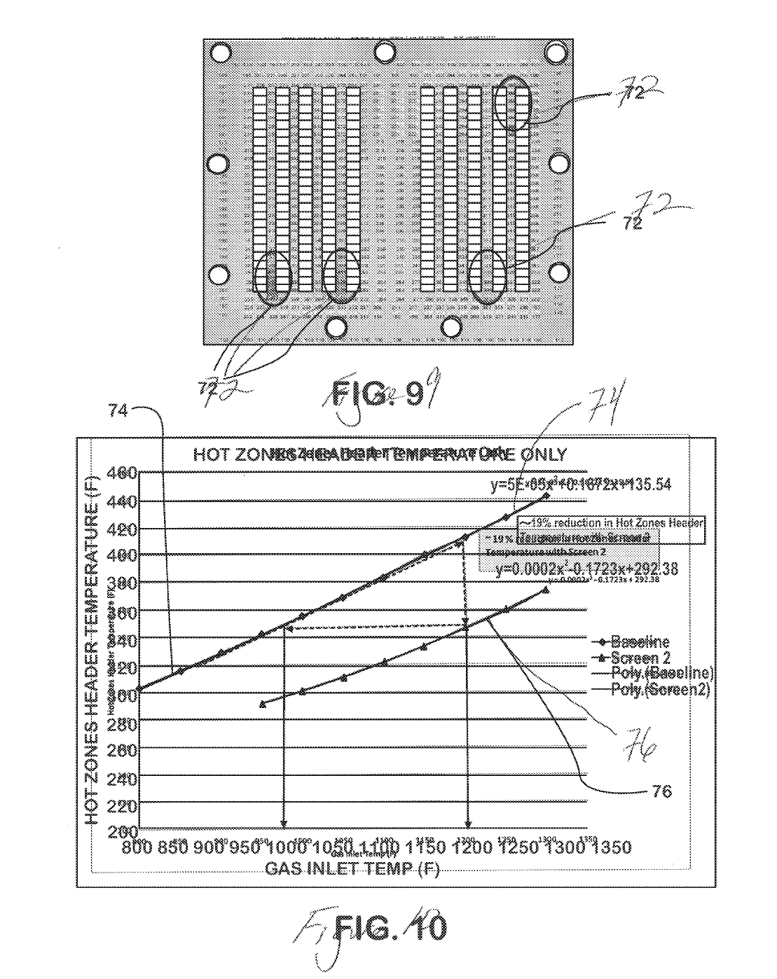

FIG. 9 illustrates four locations, from experimental measurements, in which the front side surface 68 of a header 41 experienced elevated temperatures during operation of an EGR valve 48 in the absence of a thermal screen 50. The temperatures from these four “hot zones” 72 were then used to generate a polynomial to provide a base temperature line 74, as shown in FIG. 10. The base line 74 depicts the change in temperature at these “hot zones” 72 as the temperature of the exhaust gases flowing through the header 41 increased. The temperatures at these four hot zones 72 were also measured when a thermal screen 50, without extensions 70, was positioned between the exhaust gas diffuser 58 and the header 41. Further, the thermal screen 50 included openings 62 and dividers 64 that generally conform to the shapes and locations of the openings 65 and dividers 67 of the header 41 shown in FIG. 9. The results of the temperatures of at the same “hot zones” 72 as shown in FIG. 9 when a thermal screen 50 was provided between the exhaust gas diffuser 58 and header 41 were also measured and used to create a polynomial thermal screen temperature line 76, which is also shown in FIG. 10. A comparison of the base temperature line 74 and the thermal screen temperature line 76 indicates that the use of a thermal screen 50 to direct the flow of exhaust gases into the tubes 66 of the EGR cooler 40 resulted in an approximately 19% reduction in the temperature at the “hot zones” 72. Moreover, the temperature reduction experienced through the use of a thermal screen 50 relatively significantly reduced the temperature gradient between the temperature of the front and backside surfaces 68, 70 of the header 41, thereby decreasing the potential that thermal cracks due may form and propagate in/along the header 41, such as, for example, cracks that may be generated at the “hot zones” 72. Moreover, by decreasing the potential for formation in cracks in the header 41, the use of a thermal strain 50 may extend the life of the EGR cooler 40.

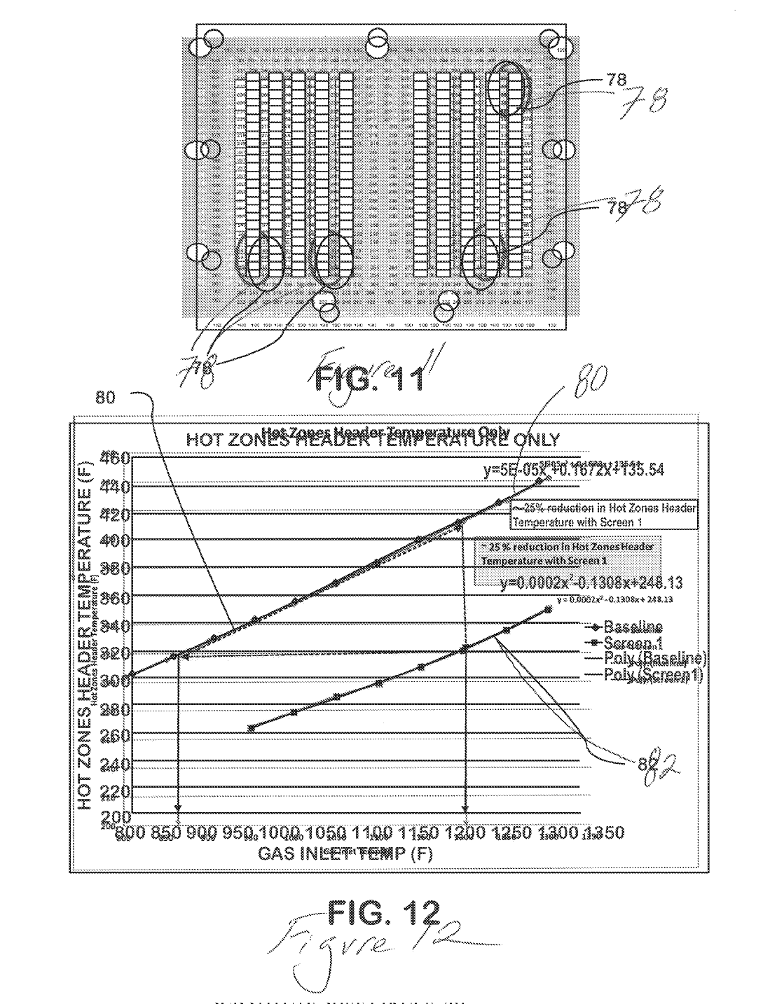

FIGS. 11 and 12 illustrate the results of similar testing at “hot zones” 78 as shown in FIGS. 9 and 10, but with the inclusion of extensions 70 of the thermal screen 50. As shown by a comparison of the thermal screen temperature line 82 and the base line temperature 80, when the thermal plate 50 included extensions 70 that could lift and/or direct at least a portion of the exhaust gas in the exhaust gas diffuser 58 through the openings 65 of the header 41, the “hot zones” 78 of the header 41 experienced an approximately 25% reduction in temperature. Such a reduction in temperature further prevents the formation and propagation of cracks in the header 41 relating to the thermal strain due to temperature differences between the front and backside surfaces 68, 70 of the header 41, and may thereby extend the life of the EGR cooler 40.

1. An exhaust gas recirculation system for diverting the flow of an exhaust gas, the exhaust gas recirculation system comprising:
an exhaust gas recirculation housing configured to house an exhaust gas recirculation valve;
a thermal screen operably connected to at least a portion of exhaust gas recirculation housing, the thermal screen positioned downstream of the exhaust gas recirculation valve; and
an exhaust gas recirculation cooler having a header positioned downstream of the thermal screen, the thermal screen configured to direct the flow of exhaust gas through the header to minimize direct exposure of a front surface of the header with the exhaust gas.

2. The exhaust gas recirculation system of claim 1, wherein the thermal screen includes a plurality of openings, the openings being configured to direct the flow of the exhaust gas into one or more tubes of the exhaust gas recirculation cooler.

3. The exhaust gas recirculation system of claim 2, wherein the exhaust gas recirculation housing includes a backside surface having a recess, the recess configured to house at least a portion of the thermal screen.

4. The exhaust gas recirculation system of claim 3, wherein the recess has a depth configured to provide a space between the housed thermal plate and at least one tube of the exhaust gas recirculation cooler.

5. The exhaust gas recirculation system of claim 4, wherein the thermal screen is maintained in the recess by a weld.

6. The exhaust gas recirculation system of claim 2, wherein the thermal screen includes a plurality of extensions, the extensions configured to direct the flow of exhaust gas out of the exhaust gas recirculation housing.

7. The exhaust gas recirculation system of claim 6, wherein the extensions extend into an exhaust gas diffuser of the exhaust gas recirculation housing, the exhaust gas diffuser being positioned downstream of at least a portion of the exhaust gas recirculation valve.

8. The exhaust gas recirculation system of claim 5, wherein the thermal screen is constructed from stainless steel.

9. An exhaust gas recirculation system for diverting the flow of an exhaust gas, the exhaust gas recirculation system comprising:
an exhaust gas recirculation housing configured to house an exhaust gas recirculation valve, the exhaust gas recirculation housing having at least one exhaust gas diffuser;
a thermal screen operably connected to at least a portion of exhaust gas recirculation housing, the thermal screen positioned downstream of the at least one exhaust gas diffuser, the thermal screen having a plurality of openings; and
an exhaust gas recirculation cooler having a header, the header being positioned downstream of the thermal screen, the openings of the thermal screen configured to direct the flow of exhaust gas through the header and to minimize direct exposure of a front surface of the header to the passing exhaust gas.

10. The exhaust gas recirculation system of claim 9, wherein each of the plurality of openings of the thermal screen are configured to direct the flow of exhaust gas into one of a plurality of tubes of the exhaust gas recirculation cooler.

11. The exhaust gas recirculation system of claim 9, wherein the exhaust gas recirculation housing includes a backside surface having a recess, the recess configured to house at least a portion of the thermal screen.

12. The exhaust gas recirculation system of claim 11, wherein the recess has a depth configured to provide a space between the housed thermal plate and the plurality of tubes of the exhaust gas recirculation cooler.

13. The exhaust gas recirculation system of claim 12, wherein the thermal screen is maintained in the recess by a weld.

14. The exhaust gas recirculation system of claim 9, wherein the thermal screen includes a plurality of extensions, the extensions configured to direct the flow of exhaust gas out of the exhaust gas recirculation housing.

15. The exhaust gas recirculation system of claim 14, wherein the extensions extend into the at least one exhaust gas diffuser.
